(19) United States
(12) Patent Application Publication
(10) Pub. No.: US 2014/0310100 A1
(43) Pub. Date: Oct. 16, 2014

(54) METHODS OF DYNAMICALLY CREATING PERSONALIZED INTERNET ADVERTISEMENTS BASED ON CONTENT

(71) Applicant: Yahoo! Inc., Sunnyvale, CA (US)

(72) Inventors: Andrei Zary Broder, Menlo Park, CA (US); Marcus Felipe Fontoura, Los Gatos, CA (US); Vanja Josifovski, Los Gatos, CA (US)

(73) Assignee: Yahoo! Inc., Sunnyvale, CA (US)

(21) Appl. No.: 14/318,049

(22) Filed: Jun. 27, 2014

Related U.S. Application Data
(63) Continuation of application No. 11/708,272, filed on Feb. 20, 2007.

(51) Int. Cl. G06Q 30/02

(52) U.S. Cl. CPC G06Q 30/0276
USPC 705/14.54; 705/14.72; 705/14.6

(57) ABSTRACT

Advertising is used to generate awareness of commercial Internet web sites. To greatly simplify the marketing of a commercial Internet web site, the automatic creation of an advertising campaign would be desirable. A method of automatically creating an Internet web site may be performed by first crawling through the Internet web site to identify products and services offered by the Internet web site. Information about the identified products and services is stored. The system then creates advertisements for the identified products and services. The advertisements may include images, text, a link to the web page where the product or service was found, and keywords associated with the product or service. The automatically created advertisements may then be placed into an advertisement pool for use with advertising supported web sites. The automatic Internet advertisement campaign creations system of the present invention may be used to create free trial advertisement campaigns for potential advertising clients.

### RELATED APPLICATIONS

The present patent document is a continuation of U.S. patent application Ser. No. 11/708,272, filed Feb. 20, 2007, pending, the entire contents of each of which are incorporated herein by reference.

### FIELD OF THE INVENTION

The present invention relates to the field of Internet advertising systems. In particular the present invention discloses techniques for automatically creating an online advertising campaign for web based retailers and service providers.

### BACKGROUND

The global Internet has become a mass medium on par with radio and television. And just like radio and television content, Internet content is largely supported by advertising dollars. The main advertising supported portion of the Internet is the “World Wide Web” that displays HyperText Mark-Up Language (HTML) documents distributed using the HyperText Transport Protocol (HTTP).

Since the Internet is a two-way media, the Internet has also become a major location of commercial activity. Billions of dollars are spent buying goods and services offered at commercial web sites such as commercial giants Amazon.com and WalMart.com. In addition to the large retailers, very small niche retailers also populate the Internet with commercial sites. Small niche retailers can compete on the Internet due to the very low start-up costs of opening a commercial web site. In fact many Internet companies such as Yahoo.com offer full-service retail web site hosting complete with web site hosting and online shopping cart management programs. In this manner, any small business owner can quickly create a commercial web site to sell goods or services on the World Wide Web without having any computer experience.

A commercial web site cannot become successful unless many people become aware of the web site. Registering the commercial web site with search engines will provide a small amount of traffic. However, in order to have a successful internet based business, one needs to advertise information about the commercial web site to potential customers. This can be done using all of the traditional advertising method such as newspapers, magazines, radio, and television. However, there is a distinct advantage to using Internet based advertising to advertise the commercial web site. Specifically, an internet advertisement can include a link that will direct the advertisement viewer directly to the commercial web site.

Large commercial web sites have sophisticated Internet-based advertising campaigns to spread the word about their web sites. However, smaller niche commercial web sites generally have no dedicated staff for creating and managing advertising campaigns. Thus, small niche commercial web sites often do not obtain the advertising that they need in order to make their sites more popular. In order to help these small niche commercial web sites, it would be very desirable to create a simple low-cost and low-maintenance method of generating an online Internet advertising campaign.

### BRIEF SUMMARY

The present invention introduces methods for automatically creating an advertising campaign for Internet web sites. The system of the present invention operates by first crawling through an Internet web site to identify products and services offered by the Internet web site. Information about the identified products and services is stored. The system then creates advertisements for the identified products and services. The advertisements may include images, text, a link to the web page where the product or service was found, and keywords associated with the product or service. The automatically created advertisements may then be placed into an advertisement pool for use with advertising supported web sites. The automatic Internet advertisement campaign creations system of the present invention may be used to create free trial advertisement campaigns for potential advertising clients.

Other objects, features, and advantages of present invention will be apparent from the accompanying drawings and from the following detailed description.

### BRIEF DESCRIPTION OF THE DRAWINGS

The objects, features, and advantages of the present invention will be apparent to one skilled in the art, in view of the following detailed description in which:

FIG. 1 illustrates a conceptual diagram that illustrates the communication between various computer systems involved in the zero-effort advertisement campaign creation system of the present invention.

FIG. 2 illustrates a high-level flow diagram that generally describes how the zero-effort advertisement campaign creation system of the present invention operates.

FIG. 3 illustrates a flow diagram that generally describes how the zero-effort advertisement campaign creation system of the present invention crawls through an Internet site and creates advertisements.

FIG. 4 illustrates a flow diagram that generally describes how the created internet advertisements are used in an advertisement campaign.

FIG. 5 illustrates a flow diagram that generally describes how the zero-effort advertisement campaign creation system of the present invention can be used to provide free trials of Internet advertising campaigns.

### DETAILED DESCRIPTION

Methods creating a zero-effort advertising campaign creation system are disclosed. In the following description, for purposes of explanation, specific nomenclature is set forth to provide a thorough understanding of the present invention. However, it will be apparent to one skilled in the art that these specific details are not required in order to practice the present invention. Furthermore, although the present invention is mainly described with reference to the World Wide Web and the HyperText Transport Protocol (HTTP) based Internet advertisements, the same techniques can easily be applied to other types of Internet advertising. For example, the present invention could easily be used with an advertising system within freely distributed programs or advertising placed in email messages sent by a free email service.

Advertising Support for Commercial World Wide Web Sites

The World Wide Web portion of the global Internet has become a mass media that largely operates using advertiser supported web sites. Specifically, web site publishers provide interesting content that attracts web site viewers. To compensate the web site publisher for creating the interesting content that attracts viewers, the publisher intersperses paid advertisements into the web pages of the web site.

Some Internet web site advertisements are ‘banner advertisements’ consisting of an advertiser-supplied image or animation. Other Internet web site advertisements merely consist of simple short strings of text. However, one thing that most Internet web site advertisements have in common is that the Internet web site advertisements contain a hyperlink (link) to another web site such that the person viewing the Internet advertisement may click on the advertisement to be directed to the advertiser's web site to obtain more information.

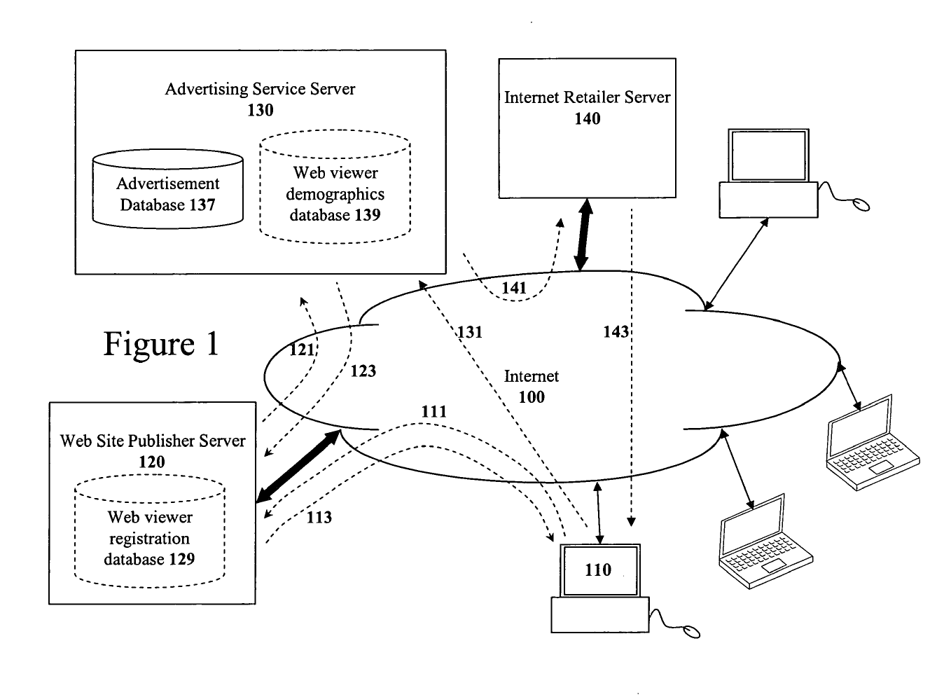

The use of Internet based advertising is ideal for Internet-based commercial entities due to that ability to link the internet advertisement to the commercial entity's Internet web site. For example, FIG. 1 illustrates an Internet based retailer server 140 that is used to sell products to Internet users. When an Internet user at personal computer 110 is browsing a web site published by web site publisher server 120, the user may be exposed to an advertisement that advertises the offerings of the Internet retailer. If the Internet user at personal computer 110 is sufficiently interested in the advertisement, the user may click on the advertisement such that the user will be re-directed to the Internet retailer server 140. In many embodiments, the user will be re-directed to the Internet retailer server 140 through an advertising service server 130 that will record the user's selection of the advertisement in order to bill the advertiser. Once the user has been re-directed to the Internet retailer server 140, the user at personal computer 110 may purchase goods or services directly from the Internet retailer server 140.

Automatic Creation of an Internet Advertising Campaign

As set forth in the background, large Internet-based retailers typically have personnel dedicated to the task of advertising their services. However, smaller commercial Internet sites often do not have dedicated personnel for handling the marketing and advertising of their Internet sites. Thus, the operators of smaller commercial Internet sites may be unfamiliar with Internet advertising options and Internet advertising procedure. Therefore, these smaller commercial Internet sites are far less likely to advertise even though these small commercial Internet sites need the advertising the most.

To remedy this situation, the present invention proposes a zero-effort advertising campaign creation system. With the teachings of the present invention, a commercial Internet site may have an advertising campaign automatically created, deployed, and results tabulated. In this manner, the owners of smaller commercial web sites that may be intimidated by the intricacies of creating and maintaining an Internet advertising campaign can be persuaded to begin advertising their commercial web site in order to generate more web site traffic and obtain more sales.

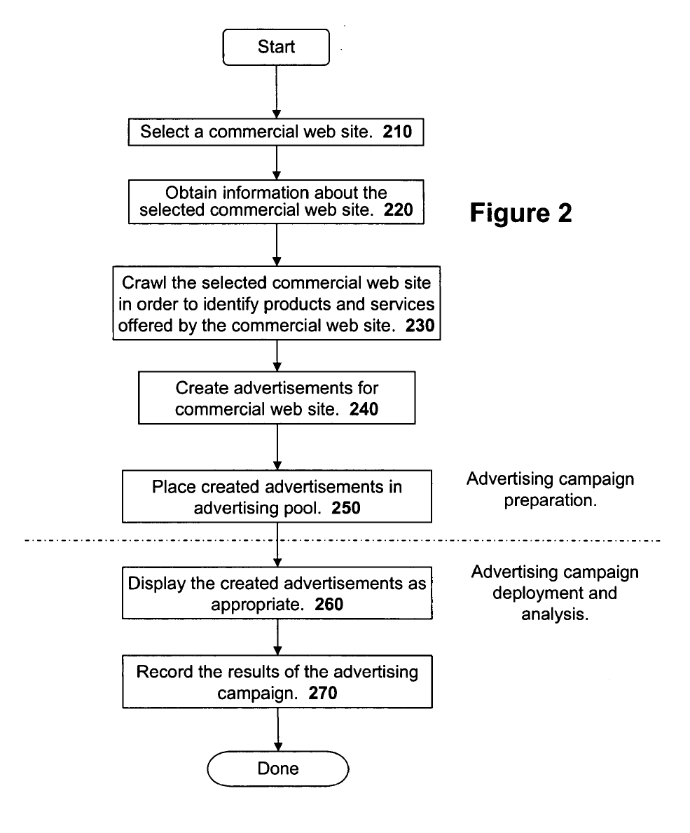

FIG. 2 illustrates a flow diagram setting forth a high level overview of the automatic generation and deployment of an Internet advertising campaign. Various steps in the overview diagram of FIG. 2 will be described in more detail in later sections of this document.

At step 210 a commercial Internet web site is selected for the automatic creation of an internet advertising campaign. This may be done by an Internet advertising representative who identifies potential new clients that may benefit from Internet advertising. Alternatively, the operators of commercial Internet web sites that are interested in trying an internet advertising campaign may contact an Internet advertising service and sign up for a trial advertising campaign.

Once an Internet commercial web site has been identified, the system obtains information about the selected commercial web site at step 220. In one embodiment, this may be done automatically by accessing the WHOIS record for the Dynamic Name Service (DNS) that hosts the domain of the commercial web site. In this manner, the system may automatically obtained the name, address, telephone number, and email address of the administrative and technical contacts for the commercial web site's Internet domain. This information is then entered into a database for the Internet advertising campaign to be created. The information may also be obtained and entered manually.

Next, at step 230, the system begins to “crawl” around the designated commercial Internet web site to learn about what the commercial Internet web site contains. Web site crawling is well known in the art of Internet search engines and generally consists of starting at a “home page” for an Internet web site, analyzing that page, and then following links to related web pages in the same domain and repeating the procedure.

During the crawl through the commercial Internet site, the system identifies a set of products and services that are offered by the commercial Internet web site. The system then stores the identified products and services along with additional information obtained about the identified products and services from the commercial Internet web site.

After crawling through the commercial Internet web site, the system creates advertisements for the commercial Internet web site as set forth step 240. Specifically, the system creates advertisements for the set of products and services that were identified in step 230. The advertisements may include an image to display, text to display, a link to the advertiser's web page where the identified product was found, a set of keywords that are associated with the product which may cause the advertisement to be displayed. The advertisements created for the identified set of products and services are then placed into an advertisement pool at step 250.

The actual advertising campaign begins at step 260. Specifically, the advertisements placed into the advertising pool are selected as appropriate and displayed to web viewers that are browsing through advertising supported web sites or using an advertising supported search engine.

Finally, at step 270, the results of the advertising campaign are tabulated. For example, each time an advertisement is displayed to a person browsing the Internet, that advertisement impression is recorded. When a person browsing an Internet web site selects an Internet advertisement, that user selection of the Internet advertisement is recorded.

Crawling a Web Site and Creating Internet Advertisements

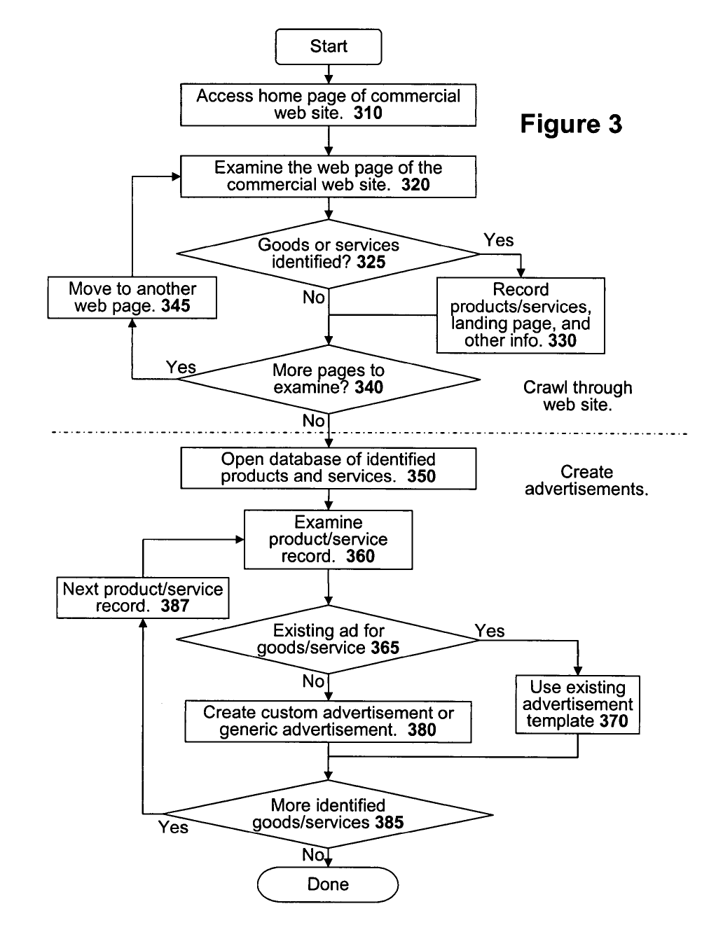

As set forth in FIG. 2, step 230 specifies that the system crawls around the selected commercial Internet web site in order to identify products and services offered by the commercial web site and step 240 specifies that the advertisements are created for the commercial web site. FIG. 3 illustrates a flow diagram that describes these steps in greater detail.

Referring to FIG. 3, the first phase is to crawl through the designated commercial internet web site. The process of crawling begins at step 310 wherein the system accesses the home page of the commercial web site. Next, the system examines the retrieved web page of the commercial web site at step 320. The examination of the web page mainly attempts to identify known products and services and links to additional web pages at the web site that will be examined.

Products and services may be identified on the web site in a number of different manners. One method of identifying products is by having a database of brand names, product names, and model numbers. For example, a system may identify a web page having the strings “Sony”, “Playstation 3”, and “$599” as a web page that offers the Sony Playstation 3 videogame console for sale. The database would specify requirements needed to identify various different products for sale.

Links to additional web pages are identified as hyperlinks in the HyperText Markup Language (HTML) source of the web page. Note that the links to follow are typically limited to be links to web pages within the same Internet domain. In this manner, any links from an Internet retailer to the web site of a product's manufacturer will be ignored. All of the links to additional web pages within the domain will be added to a list of additional web pages to examine.

After examining the web page at step 320 the system proceeds to step 325 where it determines if any products or services were identified. If any products or services were identified, the system proceeds to step 330 where the system stores various pieces of information about those products or services into a database for identified products and services. For example, the recorded information for an identified product may include the product's name, product's model or model number, an image of the product, the address of the commercial web site's web page that has the product, the price of the product/service, and any other information that would be useful for creating an advertisement for the identified product.

In addition, the system may store a set of keywords related to the products and services are identified. The keywords related to the identified products and services may be extracted from the commercial Internet web site's pages associated with the products and services. For example, a web page on an electronics retailer's Internet web site may have the title “Videogame consoles” and include the identified product “Playstation’. In such a situation, the title “Videogame consoles” may be extracted as keywords that are associated with the product “Playstation”. In addition to such extracted keywords, a set of keywords already known to be closely related to an identified product or service may also be stored with the identified product or service. These keywords may be used by an internet advertising services to determine when the advertisement should be displayed.

When the examination of the web page has been completed, the system proceeds to step 340 wherein the system determines if it needs to crawl through additional web pages. If additional web pages must be examined, then the system proceeds to step 345 and selects one of the web pages from the list of additional web pages to examine. The system then returns to step 320 to begin the examination the selected web page.

Referring back to step 340, if there are no more web pages to examine then the system proceeds to step 350 to begin the phase of creating advertisements for the identified products and services. At step 350, the database of identified products and services is opened and a first record is accessed.

At step 360, the identified product or service record is examined to determine how to create an advertisement for that product or service. At step 365, the system may access a database of existing advertisements to see if there already is an advertisement for the identified product or service. Since most retailers tend to sell many of the same products, there may already be an advertisement template for that identified product or service. Thus, if an existing advertisement template has been located for that product or service, that existing advertisement template is selected and used to create a new advertisement for this particular retailer at step 370. The advertisement created from the template may include an image to display, text to display, a link to the advertiser's web page where the identified product was found, and a set of keywords that are associated with the product which may cause the advertisement to be displayed.

If no existing advertisement exists for the identified product or service, then system needs to create a new advertisement at step 380. A custom advertisement may be created for the product or service by combining the name and or logo of the commercial web site with the name of the product or service. A generic advertisement may be created by using the product's brand name and model number. The generic advertisements may include an image obtained from the commercial Internet web site page, text to display from the commercial Internet web site page, a link to the commercial web site's web page where the identified product was found, and a set of keywords that are associated with the product which may cause the advertisement to be displayed. It may be desirable to have a human look over all the generic advertisements created in order to make sure they are correct.

Instead of an advertisement for the specific product or service, a generic or customized “class” advertisement may be created for the generic class of products or services that the identified product or service fits within. For example, if a Samsung DLP flat-screen television is the identified product, a generic class advertisement for “televisions” may be created or a customized “Televisions at Best Buy” advertisement may be created.

After creating the advertisement, the system proceeds to step 385 to determine if there are additional products and services. If additional identified products and services exist in the database, the system proceeds back to step 360 to create additional advertisements. Otherwise, the system has completed the task of crawling through the target commercial web site and creating advertisements for the commercial web site.

Using Internet Advertisements

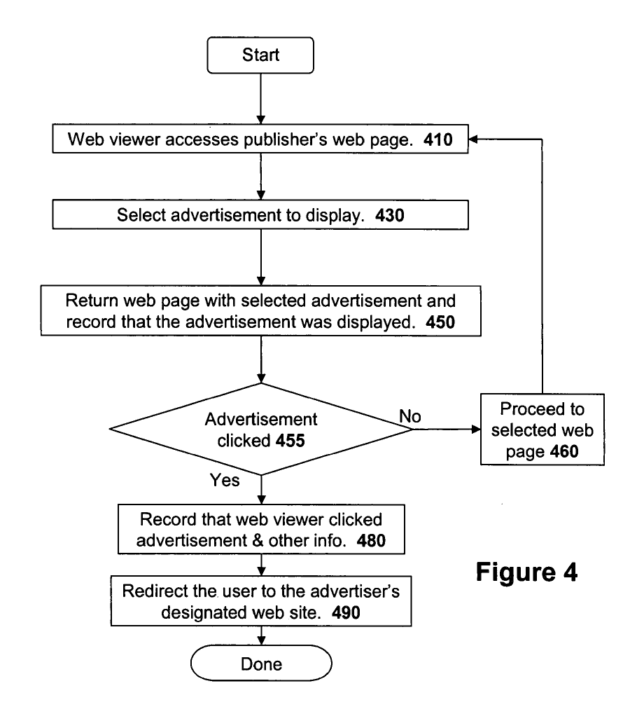

The Internet advertisements created by the present invention can be used in existing Internet advertising systems. FIG. 4 illustrates the general procedure for using the automatically created Internet advertisements within an Internet advertising network.

Referring to FIG. 4, a web viewer accesses an advertising-supported web publisher's site at step 410. This can be illustrated conceptually by request 111 on the conceptual diagram of FIG. 1. To respond to the web viewer's request, the web site publisher server 120 creates a web page that includes advertisements that will be delivered to the web viewer.

At step 430, the system selects an advertisement to display to the user from a pool of available advertisements. This is illustrated conceptually in FIG. 1 by an advertisement request 121 to an advertising service server 130. In a preferred embodiment, the advertising system attempts to select an advertisement from an advertisement database 137 that will greatly appeal to the web viewer that is viewing the web publisher's web site.

One method of selecting an advertisement that may appeal to the web viewer is to select an advertisement with associated keywords that are in the web page that will be delivered to the user. For example, if the web page to be delivered includes the phrase “DLP televisions are ideal for use with videogame systems due to the fact that there is no ‘burn in’ associated with DLP televisions” then the system may select advertisements with the associated keywords “DLP”, “television”, or “videogame”. Similarly, the advertisement may be selected using its associated keywords when a web viewer enters the associated keywords into an Internet search engine. Referring again to FIG. 1, the selection of an advertisement may be also performed by consulting any demographics known about the user (in web viewer demographics database 139 or web view registration database 129), or by any other number of advertising targeting systems. The advertising service server 130 returns the advertisement selected from the advertisement database 137 to the web site publisher server 120 in advertisement response 123.

After obtaining the advertisement from the advertising server 130, the web site publisher's server 129 then provides the web page requested by the user along with the selected advertisement as set forth in step 450. This is conceptually illustrated by web page reply 113. The user's local computer system will display the web page to the user.

At step 455, the system determines if the person viewing the web page clicks on the advertisement. If the web viewer clicks on the selected advertisement at step 455, then the system records the web viewer's advertisement selection (in order to charge the advertiser for the click-through) at step 480 and then directs the web viewer to the advertiser's designate web site at step 490. This occurs by directing the user along request 131 to the advertising service server 130 that records the advertisement click and then redirects the request to Internet Retailer server 140 along request 141. The Internet Retailer server 140 responds to the request by replying to the user's Personal computer 110 along response 143. Otherwise, if the user did not select the advertisement back at step 455, then the system proceeds to the web page selected by the web viewer as set forth in step 130.

Free Internet Advertisement Trials

With the zero-effort advertising campaign creation system of the present invention Internet advertisement services can offer free Internet Advertisement trials to the operators of commercial Internet sites. In this manner, operators of small commercial Internet sites with little experience with advertising and commercial Internet site operators that are skeptical of advertising can try advertising for free before making a decision as to whether to sign up for the advertising service.

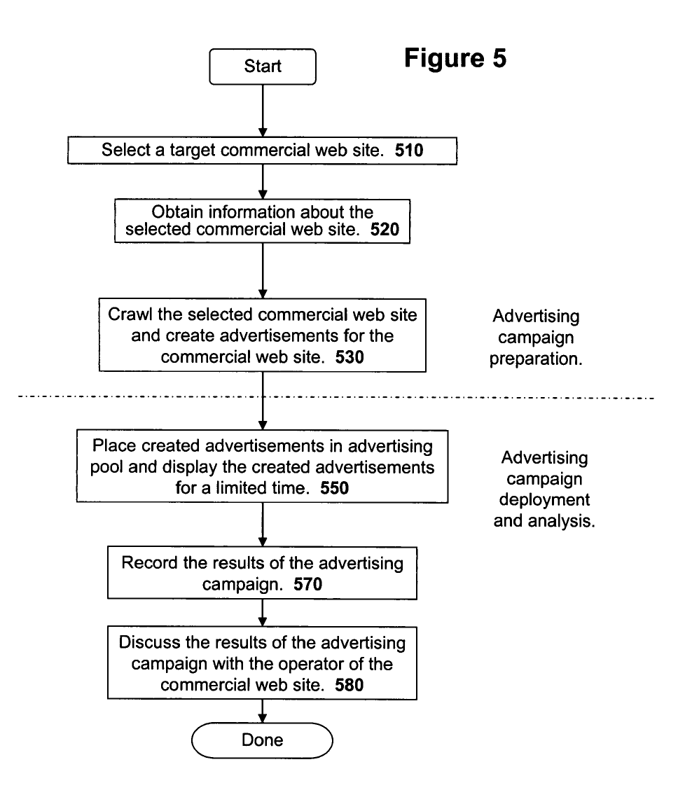

FIG. 5 illustrates a high-level flow diagram of how a free Internet Advertisement trial may be performed. Initially, at step 510 a target commercial Internet web site is selected. This may be done by an Internet advertising salesman that identifies a potential new client for an Internet advertising service. Alternatively, the advertising service may advertise the free advertising trial offer to potential clients such that the operators of various commercial Internet web sites may contact the Internet advertising service and sign up for the free trial Internet advertising campaign.

Once an Internet commercial web site has been identified, the system obtains information about the selected commercial web site at step 520. As set forth early, this may be done automatically by accessing the WHOIS record for the Dynamic Name Service (DNS) that hosts the domain of the commercial web site to obtain information about the commercial Internet site. Alternatively, if the operator of an commercial Internet site may enter this information into an online form when signing up for the free trial Internet advertising campaign. The information is entered into a database for the free trial Internet advertising campaign to be created.

Next, at step 530, the system of the zero-effort advertising campaign creation system of the present invention crawls the target commercial Internet web site to learn about what the commercial Internet web site contains and automatically creates advertisements. Details on this process were set forth earlier with reference to FIG. 3. The system then places the automatically created advertisements into an advertisement pool at step 550.

Once the advertisements have been placed into the advertisement pool, the actual advertising campaign begins. The advertisements placed into the advertising pool are selected as appropriate and displayed to people that are browsing through advertising supported web sites. The advertisements may be left in the advertisement pool until a pre-determined metric is reached. For example, the advertisements may be left in the advertisement pool for a pre-determined time limit. Alternatively, the advertisements may be left in the advertisement pool until a specified number of “click-throughs” occur (wherein an Internet user clicks on the advertisement such that they are re-directed to the commercial Internet web site.)

During and at the end of the advertising campaign the results of the advertising campaign are tabulated as set forth by step 270. Thus, every time that an advertisement is displayed to a person browsing the Internet and every time a person browsing the Internet selects a displayed advertisement, information about those occurrences is recorded. If the Internet advertising service also provides web site hosting services and web site shopping cart services, then the Internet advertising service can also record when a user that selected an advertisement also purchased a product. In this manner, a direct connection between advertising and sales due to the advertising can be established to prove the usefulness of advertising.

Finally, the Internet advertising salesman from the advertising service can discuss the results of the free trial Internet advertising campaign with the operator of the target commercial Internet site as set forth in step 580. With detailed information on the effects of the advertising, the salesman from the Internet advertising service may be able to persuade the operator of the target commercial Internet site to sign up for additional advertising services.

The foregoing has described a number of techniques for dynamically creating customized Internet advertisements. It is contemplated that changes and modifications may be made by one of ordinary skill in the art, to the materials and arrangements of elements of the present invention without departing from the scope of the invention.

1. A method of creating an Internet advertisement campaign for an advertiser, the method comprising:
examining web pages of a plurality of commercial Internet sites other than a commercial internet site of the advertiser;
extracting a set of features from a web page of the web pages;
analyzing the set of features to identify a product or service described on at least one commercial internet site of the plurality commercial Internet sites;
creating an Internet advertisement of the Internet advertisement campaign for advertisement by the advertiser; and
repeating the steps of examining, analyzing and creating to create additional Internet advertisements for advertisement by the advertiser

2. The method of creating an Internet advertisement campaign of claim 1 wherein analyzing the set of features comprises:
comparing the set of features with a set of known products and services of the advertiser.

3. The method of creating an Internet advertisement campaign of claim 1 further comprising:
identifying at least one keyword of the web page associated with the product or service;
storing the at least one keyword;
receiving a search request from a web viewer entering the keyword into a search engine; and
selecting the Internet advertisement for display to the web viewer.

4. The method of creating an Internet advertisement campaign claim 1 further comprising
identifying at least one keyword of the web page associated with the product or service;
storing the at least one keyword;
identifying the at least one keyword in text of a web page to be delivered to a web viewer; and
selecting the Internet advertisement for display based upon said keyword existing in the web page to be delivered to the web viewer.

5. A method comprising:
at an advertising service computer system,
identifying a potential advertiser having a retailer server computer for selling products or services to Internet users at a commercial Internet web site of the potential advertiser;
identifying one or more commercial internet web sites other than the commercial Internet web site of the potential advertisers;
examining web pages of the identified one or more commercial Internet web sites;
identifying products and services offered on the examined web pages of the identified one or more commercial Internet web sites;
storing identifying information for the identified products and services and additional information about the identified products and services contained on the examined web pages;
automatically creating one or more advertisements for the use by the potential advertiser to advertise products and services of the potential advertiser at the commercial Internet web site of the potential advertiser; and
offering an advertisement campaign including the one or more advertisements to the potential advertiser.

6. The method of claim 5 wherein examining web pages of the identified one or more commercial Internet web sites comprises:
retrieving stored product names and brand names of interest;
identifying on the web pages of the identified one or more commercial Internet web sites the retrieved product names and brand names of interest; and
storing information about the products and services offered on the web pages.

7. The method of claim 5 further comprising:
determining if any products or services are offered on examined web pages;
storing information about the offered products or services; and
using the stored information to create the one or more advertisements.

8. The method of claim 7 wherein storing information about the offered products or services comprises:
identifying one or more keywords related to the offered products or services;
storing data defining the one or more keywords;
and wherein creating the one or more advertisements comprises:
associating the one or more keywords with advertisements of the one or more advertisements.

9. A computer implemented method comprising:
by a processor of an advertising service server system,
retrieving from a database information about known products or services of interest to a new advertiser;
retrieving web pages of a web site of interest to the new advertiser;
locating product information about products or services in the retrieved web pages by comparing the retrieved information about known products or services with information of the retrieved web site of interest to the new advertiser;
storing in a database information about the products or services for which information was located in the retrieved web pages;
creating advertisements for the products or services for which information was located in the retrieved web pages, including
identifying in an advertisement database a pre-existing advertisement of another advertiser for a product or service for which information was located in the retrieved web pages; and
creating a new advertisement for the new advertiser using the pre-existing advertisement of the other advertiser as a template.

10. The method of claim 9 wherein creating a new advertisement for the new advertiser comprises:
including in the new advertisement an image to display, text to display, a link to a specific web page of the web site of interest to the new advertiser where the products or services for which information was located in the retrieved web pages was located, and one or more keywords associated with a product or service.

11. The method of claim 9 wherein creating a new advertisement for the new advertiser comprises:
if no pre-existing advertisement is identified, creating the new advertisement for the new advertiser by combining a name or logo of the web site of interest to the new advertiser with a name of the products or services for which information was located in the retrieved web pages.

12. The method of claim 9 wherein creating a new advertisement for the new advertiser comprises:
if no pre-existing advertisement is identified, creating the new advertisement for the new advertiser by combining a brand name or model number of the products or services for which information was located in the retrieved web pages with an image or text obtained from the web site of interest to the new advertiser, a link to a specific web page of the web site of interest to the new advertiser where the products or services for which information was located in the retrieved web pages was located.

13. The method of claim 9 further comprising:
storing in a database keywords related to the products or services for which information was located in the retrieved web pages,
and wherein creating advertisements for the products or services for which information was located in the retrieved web pages comprises:
retrieving keywords from the database, and
including in the advertisements one or more keywords retrieved from the database.

14. A method for initiating a new advertiser on an online advertising system, the method comprising:
at a computer system configured to implement the online advertising system,
identifying a web site of the new advertiser;
retrieving from storage a database of product information;
retrieving individual web pages of the web site of the new advertiser;
comparing text data and image data of the individual web pages with records of the database of product information;
upon a match between text data or image data from a particular web page and a database record, storing information from the particular web page about identified products in an identified product database, including storing product name information, product model information, and a network address of the particular web page;
creating an advertisement for a product for the new advertiser by accessing a database of existing advertisements;
selecting an existing advertisement of another advertiser for the product;
modifying the existing advertisement of the other advertiser to create a new advertisement for the new advertiser by
retrieving from the identified product database the stored product name information, the stored product model information and the network address of the particular web page, and substituting in the existing advertisement the retrieved product name information, the retrieved product model information and the retrieved network address of the particular web page of the new advertiser; and
subsequently, selecting the new advertisement for display to a web viewer, and providing a requested web page to the web viewer along with the new advertisement.

15. The method of claim 14 wherein storing information from the particular web page further comprises:
extracting one or more keywords related to the identified products from the particular web page; and
storing the one or more keywords in the identified product database.

16. The method of claim 15 wherein selecting the new advertisement for display to a web viewer comprises:
identifying text information in the requested web page;
comparing the text information in the requested web page with the stored keywords in the identified product database; and
if there is a match between the stored keywords for the new advertisement and the text information in the requested web page, selecting the new advertisement for presentation to the web viewer.
